(19) United States
(12) Patent Application Publication
(10) Pub. No.: US 2015/0109214 A1
(43) Pub. Date: Apr. 23, 2015

(54) Methods and Apparatuses of touch-fingerprinting Display

(71) Applicants: Weidong Shi, Pearland, TX (US); Yang Lu, Pearland, TX (US)

(72) Inventors: Weidong Shi, Pearland, TX (US); Yang Lu, Pearland, TX (US)

(21) Appl. No.: 14/059,592

(22) Filed: Oct. 22, 2013

(51) Int. Cl. G06F 3/044

(52) U.S. Cl. CPC G06F 3/044
USPC 345/173

(57) ABSTRACT

The present invention describes methods and apparatuses for sensing touches and/or fingerprint images with an integrated touch-fingerprinting display comprising, a pattern of display pixels wherein said display pixels are controllable components of an electronic display, a pattern of fingerprint imaging cells, a display driver coupled with the display pixels wherein said display driver can control states of the display pixels, and a fingerprint readout circuit coupled with the fingerprint imaging cells. Furthermore, a computing apparatus can display a user interface on a touch-fingerprinting display, detect touches from a user, and then scan one or multiple fingerprint images from the user. In further embodiments, the computing apparatus can compute a biometric token based on the scanned fingerprint data and use the biometric token as identity proof to access a local resource or networked resource.

The present application is a continuation-in-part of U.S. application Ser. No. 13/459,207, entitled “Methods and Apparatus of Integrating Fingerprint Imagers with Touch Panels and Displays”, filed Apr. 29, 2012; The present application is also a continuation-in-part of U.S. application Ser. No. 13/667,235, entitled “Methods and Apparatus for Managing Service Access Using a Touch-Display Device Integrated with Fingerprint Imager”, filed Nov. 2, 2012. The present application is also a continuation-in-part of U.S. application Ser. No. 13/757,993, entitled “Methods and Apparatuses of Transparent Fingerprint Imager Integrated with Touch Display Device”, filed Feb. 4, 2013. The present application is also a continuation-in-part of U.S. application Ser. No. 13/851,086, entitled “Methods and Apparatuses of User Interaction Control with Touch Display Device Integrated with Fingerprint Imager”, filed Mar. 26, 2013. The present application is also a continuation-in-part of U.S. application Ser. No. 13/887,351, entitled “Methods and Apparatuses of Unified Capacitive Based Sensing of Touch and Fingerprint”, filed May 5, 2013. All of which are hereby incorporated by reference in their entireties.

### BACKGROUND OF THE INVENTION

### Field of the Invention

This invention relates to identity management and/or access control using computing apparatus integrating fingerprint scan with touch interaction.

### BRIEF DESCRIPTION OF THE DRAWINGS

The invention may be better understood, and further advantages and uses thereof more readily apparent, when considered in view of the following detailed description of exemplary embodiments and examples, taken with the accompanying diagrams, in which:

FIG. 1 is a block diagram showing, in one exemplary embodiment of the present invention, the components of a computing apparatus comprising a touch-fingerprint display, a transceivers, and an electronic storage device;

FIG. 2 is a block diagram showing, in one exemplary embodiment of the present invention, a touch-fingerprint display comprising a transparent fingerprint imaging apparatus integrated with an electronic display;

FIG. 3 is a block diagram showing, in one exemplary embodiment of the present invention, a touch-fingerprinting display comprising a transparent electronic display and a fingerprint imaging apparatus;

FIG. 4 is a block diagram showing, in one exemplary embodiment of the present invention, a touch-fingerprinting display comprising transparent fingerprint imaging cells integrated with an electronic display;

FIG. 5 is a block diagram showing, in one exemplary embodiment of the present invention, a touch-fingerprinting display comprising a layered structure with the fingerprint imaging cells integrated with the display module itself;

FIG. 6 is a block diagram showing, in one exemplary embodiment of the present invention, a pattern of display pixels and fingerprint imaging cells, display driver, fingerprint imaging driver, and readout circuit;

FIG. 7 is a block diagram showing, in one exemplary embodiment of the present invention, the components of a touch-fingerprinting controller comprising a display controller, a touch sensing controller, and a fingerprint imaging controller;

FIG. 8 is a flowchart showing, in one exemplary embodiment of the present invention, the process of verifying user identity by a computing apparatus during the user's interaction with a user interface artifact; and

FIG. 9 is a flowchart showing, in one exemplary embodiment of the present invention, the process of transmitting user identity over a network by a computing apparatus during the user's interaction with a computing apparatus.

While the patent invention shall now be described with reference to the embodiments shown in the drawings, it should be understood that the intention is not to limit the invention only to the particular embodiments shown but rather to cover alterations, modifications and equivalent arrangements possible within the scope of appended claims. Throughout this discussion that follows, it should be understood that the terms are used in the functional sense and not exclusively with reference to a specific embodiment, or implementation.

### DETAILED DESCRIPTION OF THE PREFERRED EMBODIMENTS

Discussion in this section is intended to provide a brief description of some exemplary embodiments of the present invention.

FIG. 1 is a block diagram showing, in one exemplary embodiment of the present invention, the components of a computing apparatus (e.g., laptop, or desktop, or tablet, or notebook, or PDA, or mobile Internet device, or mobile phone, or handheld gaming device, or Kiosk) that comprises a touch-fingerprinting display, one or a plurality of transceivers, one or a plurality of electronic storage devices.

In some exemplary embodiments, a touch-fingerprinting display (3000) can comprise, a pattern of display pixels wherein said display pixels are controllable components of an electronic display, a pattern of fingerprint imaging cells wherein said fingerprint imaging cells are interspersed among or placed on top of or placed beneath the display pixels, a display driver coupled with the display pixels wherein said display driver can control states of the display pixels, and a fingerprint readout circuit coupled with the fingerprint imaging cells wherein said fingerprint readout circuit senses output of the fingerprint imaging cells.

An electronic display is an output device for presentation of information in visual form (e.g., liquid crystal display devices such as TFT-LCD, or Ferro LCD, or OLED displays, or electronic paper display, or interferometric modulator display, or electrowetting display).

In some exemplary embodiments of the present invention, a display pixel is a physical point in a raster image, or an addressable or controller element of a display device. An image can be presented on an electronic display by controlling the states of the display pixels. In some exemplary embodiments, pixels can be manufactured as addressable components in a two-dimensional display. The address of a display pixel can correspond to its physical coordinates. In further exemplary embodiments, a display pixel can comprise a plurality of sub pixel components (e.g., red, or green, or blue, or cyan, or magenta, or yellow, or black). Depending on the embodiments, a display pixel or sub pixel components can emit light or reflect light or modulate light or pass-through light using color filters (e.g., red filter, or green filter, or blue filter).

In some exemplary embodiments of the present invention, a display driver is a circuit that controls the states of the display pixels. Depending on the embodiments, a display driver can provide an interface between a display controller (e.g., standalone display controller, or an integrated circuit comprising a display controller) and a display device (e.g., LCD, or FLCD, or OLED, or electronic paper, or electrowetting display). In further exemplary embodiments, a display driver can respond to display commands and/or display data using a communication interface (e.g., TTL, or RS232, or SPI, or I2C, or display serial interface, or low-voltage differential signaling, or USB, or HDMI, or DVI) to make the display to show text or image.

In some exemplary embodiments, a touch-fingerprinting display controller can comprise a display controller. Depending on the embodiments, a display driver or display controller can comprise an application-specific micro-controller or ASIC (application specific integrated circuit) components or a GPU (graphic processing unit). In further exemplary embodiments, a display driver or display controller can comprise RAM (random access memory) and/or non-volatile memory (e.g., flash memory, or EEPROM, or ROM).

In some exemplary embodiments, a touch-fingerprinting display can comprise an electrophoretic display. Depending on the embodiments, an electrophoretic display can comprise display pixels (e.g., microcapsules) that are held between two arrays of electrodes.

In some alternative exemplary embodiments, a touch-fingerprinting display (3000) can comprise an OLED display where the display pixel is an organic light emitting diode display pixel. In further alternative exemplary embodiments, the OLED display can be transparent OLED (e.g., TOLED).

In other alternative exemplary embodiments, a touch-fingerprinting display (3000) can comprise a liquid crystal display (LCD). Depending on the embodiments, a LCD display can use the light modulating properties of liquid crystals for showing an image. In further alternative exemplary embodiments, the LCD display can be a ferro liquid crystal display.

In some exemplary embodiments, a fingerprint imaging cell (e.g., capacitive fingerprint imaging cell, or optical fingerprint imaging cell, or mechanical fingerprint imaging cell) is a sensor circuit that can sense touch of human finger and/or sense the friction ridges of any part of a human or other primate hand. Depending on the embodiments, the embodiments of a fingerprint imaging cell can comprise fingerprint imaging sensor including but not limited to, optical fingerprint imaging sensor, or ultrasonic fingerprint imaging sensor, or thermal fingerprint imaging sensor, or capacitive fingerprint imaging sensor, or MEMS based fingerprint imaging sensor, or Nano-based fingerprint imaging sensor (e.g., nano tubes, or nano wires). A touch-fingerprinting display (3000) can comprise a pattern of fingerprint imaging cells.

In some exemplary embodiments of the present invention, fingerprint imaging cells can be used for detecting touch presence and/or touch location from one or a plurality of human fingers. Furthermore, fingerprint imaging cells can be used for scanning fingerprint image or fingerprint images.

In some alternative exemplary embodiments, in addition to fingerprint imaging cells, a touch-fingerprinting display (3000) can comprise a touch panel (e.g., capacitive touch panel, or resistive touch panel, or acoustic wave touch panel, or infrared touch panel, or projective capacitive touch panel). In further exemplary embodiments, a touch panel can be integrated with a display device using out-cell, or on-cell, or in-cell technique. In the exemplary embodiments where a touch-fingerprinting display (3000) comprises both fingerprint imaging cells and a touch panel, fingerprint imaging cells can be overlayed on top of a touch panel, or be situated between a touch-panel and a display device, or be placed beneath a touch-panel, or integrated with a touch panel).

In some exemplary embodiments of the present invention, a fingerprint imaging cell can comprise a capacitive sensor. A capacitive sensor can sense the capacitance change inducted by human touch and/or sense the capacitance difference produced by ridge and valley of human or other primate hand. A capacitive sensor can be addressed by a column address and/or scanline address. Its sensing output can be transmitted over a data line or column line. The sensing output can be amplified and then converted into digital signal by a comparator or an analog-to-digital converter. Depending on the embodiments, a touch-fingerprinting controller can use the capacitive sensors to detect touch presence and/or scan fingerprint images. Furthermore, the fingerprint imaging cells can be overlayed on top of a display device (e.g., liquid crystal display device such as TFT-LCD, or Ferro LCD, or OLED display, or electronic paper display, or interferometric modulator display, or electrowetting display) using out-cell or on-cell technique, or integrated with a display device (e.g., liquid crystal display device such as TFT-LCD, or Ferro LCD, or OLED display, or electronic paper display, or interferometric modulator display, or electrowetting display) using in-cell technique. In some exemplary embodiments of in-cell integration of fingerprint imaging cells with a display device (e.g., LCD, or OLED display, or TOLED, or FLCD), fingerprint imaging cells can be placed as neighbors of display pixels.

Furthermore, a fingerprint imaging cell can comprise one or a plurality of thin-film transistors. Depending on the embodiments, a fingerprint imaging cell can use a thin-film transistor as a switch for charging a capacitive sensor, or use a thin-film transistor as a switch for discharging a capacitive sensor, or use a thin-film transistor as an amplifier that amplifies the signal difference between touch and no-touch, or amplifies the signal difference between fingerprint ridge and valley.

In some exemplary embodiments where a touch-fingerprinting display (3000) comprises a grid of fingerprint imaging cells that are used for touch detection and/or fingerprint image scan. In some exemplary embodiments, fingerprint imaging cells can be manufactured using transparent electronic devices and/or transparent electronic fabrication processes. The fingerprint imaging cells can be optically transparent. In an exemplary implementation, components of a transparent fingerprint imaging cell can be made using transparent capacitance sensing electrode (e.g., optically transparent conductive material), and transparent dielectric. Transparent conductive materials include but not limited to transparent inorganic materials, or transparent organic materials. Examples of inorganic materials include TCO (transparent conducting oxide), or fluorine doped tin oxide (FTO), or doped zinc oxide, etc. In further exemplary embodiments, the thin-film transistors (TFT) can be transparent by using transparent semiconductors (e.g., transparent amorphous oxide materials, or transparent organic thin-film transistors, or transparent in-organic thin-film transistors, or transparent nano-wire transistors, or transparent nanotube transistors).

In some exemplary embodiments of the present invention, a fingerprint imaging cell can comprise an optical imaging sensor (e.g., charge-coupled device (CCD) sensor, or complementary metal oxide semiconductor (CMOS) sensor) or an infrared fingerprint cell. In further exemplary embodiments, a fingerprint imaging cell can comprise one or a plurality of micro-lens.

In some exemplary embodiments, a computing apparatus can comprise a touch-fingerprinting controller (1200) coupled with a touch-fingerprinting display (3000). The touch-fingerprinting controller (1200) can comprise, a touch sensing controller that can determine touch location from output of the touch-fingerprinting display (3000), and/or a display controller that can switch the states of the display pixels, and a fingerprint imaging controller that is coupled with the fingerprint imaging cells.

In some exemplary embodiments, a computing apparatus can comprise one or a plurality of control processing elements. A control processing element is an electronic circuit that executes computer programs. A control processing element can be implemented as system on a chip (SoC). A system on a chip or system on chip (SoC or SOC) is an integrated circuit (IC) that integrates components of a computer or other electronic system into a single chip. It may contain digital, or analog, or mixed-signal, or radio-frequency functions all on a single chip substrate. Sometimes, a SoC processor can be designed for supporting applications executed by a mobile computing system (e.g., tablet, or mobile phone, or mobile Internet device, or handheld gaming device, or PDA).

In some exemplary embodiments, a transceiver (1800) (e.g., RF transceiver, ethernet transceiver) is a device comprising both transmitter and receiver handling circuitry. A RF transceiver uses RF (radio frequency) modules for data transmission.

In some exemplary embodiments, an electronic storage device (1500) is any medium that can be used to record information electronically (e.g., volatile DRAM, or non-volatile storage, or solid state drive, or hard disk, or flash memory). In an exemplary embodiment, an electronic storage device (1500) can comprise nonvolatile random access memory. A non-volatile random access memory retains its information when power is turned off (non-volatile). The memory can be integrated on-chip (e.g., non-volatile SRAMs, or on-chip flash memory) or it can be off-chip (e.g., flash memory, or ferroelectric RAM, or magnetoresistive random-access memory, or phase-change memory, or nano-RAM, or millipede memory, or resistive random-access memory). In an exemplary embodiment, a computing apparatus can store fingerprint templates in a non-volatile storage device.

In additional exemplary embodiments, the computing apparatus can comprise a user interface processor (1700). A user interface processor (1700) can display a user interface on the touch-fingerprinting display (3000), process user touch, and respond accordingly.

In an exemplary embodiment, a user interface can comprise one or a plurality of user interface artifacts. An interface artifact can be a graphic user interface component (e.g., button, or icon, or menu, or widget). In an exemplary embodiment of the present invention, a user interface artifact can comprise, a home button, or an icon of an application, or a search button, or a back button, or a start button (e.g., power on), or a restart button, or a power off button, or a setting button, or a browser button, or a file open button, or a submit button, or a login button, or a logoff button, or a confirm button, or a ok button, or a cancel button, or an application launch button, or a virtual keypad.

A keypad is a set of buttons arranged in a block or “pad” which usually bears digits, symbols and a set of alphabetical letters. Keypads are found on many alphanumeric keyboards and on other devices such as calculators, push-button telephones, combination locks, digital door locks. A virtual keypad is a keypad shown by an interface processor (1700) on a touch-fingerprinting display (3000).

In some exemplary embodiments, the user interface can be rendered by a display controller or a GPU (graphics processing unit).

In an exemplary embodiment, a user interface artifact can be a static or a dynamic component. In an exemplary embodiment, when a user interface artifact is pressed or touched or selected, certain response can be triggered. In some exemplary embodiments of the present invention, when a user interface artifact (e.g., icon, or button, or menu, or widget) is displayed on the touch-fingerprinting display (3000), fingerprint image of a user can be scanned when the user touches the user interface artifact.

In an exemplary embodiment, a user interface processor (1700) can be implemented as a program and executed by one or a plurality of control processing elements. The program can be stored in a storage device (1500) of the computing apparatus.

In further exemplary embodiments, a computing apparatus can comprise a biometric processor (1600), and an identity verifier (1400). A biometric processor (1600) can enroll and/or match fingerprints.

A biometric processor (1600) is a component used for enrolling and/or matching fingerprints. A captured fingerprint image can be digitally processed by the biometric processor (1600) to create a biometric template (e.g., a collection of extracted features) which is stored in a storage device (1500) and used for matching. In further exemplary embodiments, a biometric processor (1600) can create one or a plurality of electronic biometric tokens from one or a plurality of scanned fingerprint images.

In some exemplary embodiments, a computing apparatus can comprise an identity verifier that can compare a scanned fingerprint image or compare features extracted from a scanned fingerprint image with one or a plurality of registered fingerprint templates wherein said registered fingerprint templates are created from fingerprint images of one or a plurality of authorized persons.

In some exemplary embodiments, the computing apparatus can comprise a transaction processor (1300) coupled with the transceivers (1800). In additional exemplary embodiments, the transaction processor (1300) can transmit an electronic biometric token over a transceiver (1800).

It is worth to point out that the described embodiments are only for illustration purpose. Equivalent embodiments may be readily apparent to those of ordinary skill in the art. The present invention should not be limited only to the described embodiments herein.

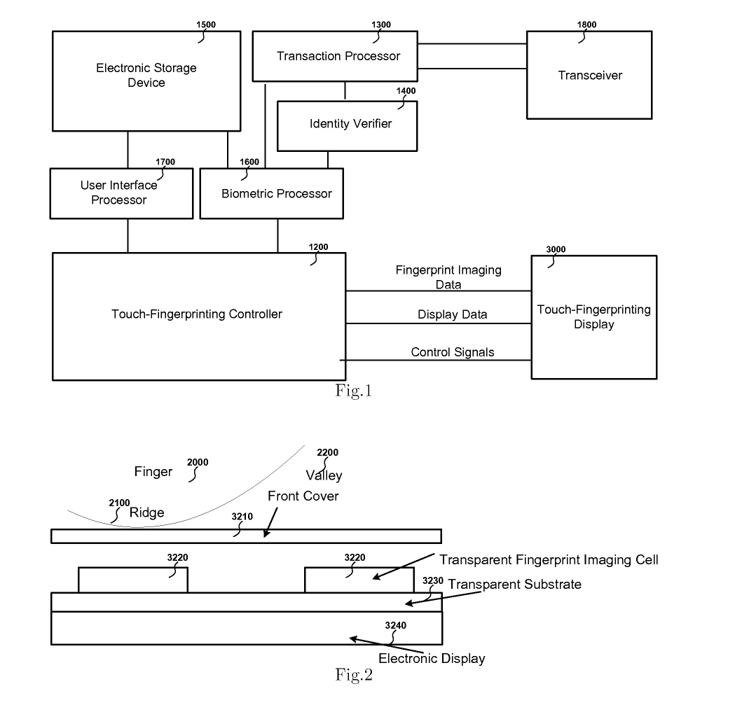

FIG. 2 is a block diagram showing, in one exemplary embodiment of the present invention, a touch-fingerprinting display comprising a transparent fingerprint imaging apparatus integrated with an electronic display.

In some exemplary embodiments, a transparent fingerprint imaging apparatus can comprise a transparent fingerprint imaging cell array that further comprises a matrix of fingerprint imaging cells (3220). In further exemplary embodiments, a fingerprint imaging cell can comprise a transparent capacitive sensor that can sense the difference between the ridge and valley of human finger and/or hand. Using the principle of capacitance sensing, a transparent capacitive sensor is designed to pick up the difference between finger ridge and valley by inducing a different value in current or voltage. The difference can be further amplified, and converted into digital signal by one or a plurality of analog-to-digital converters, or by one or a plurality of analog-to-digital comparators. Furthermore, a transparent fingerprint imaging apparatus can comprise a cover (3210) and a transparent substrate (e.g., glass, or plastic) (3230).

When an embodiment comprises transparent capacitive sensors, depending on the implementation, a capacitive sensor can connect to a scanline, and a column line. A capacitive sensor can further comprise, a transparent sensing electrode, and one or a plurality of transparent thin-film transistors. The transparent sensing electrode can connect to one of the terminals of one of the transparent thin-film transistors. The scanline can connect to the gate of one of the transparent thin-film transistors.

In accordance with the present invention, there can be multiple alternative exemplary embodiments of a transparent capacitive sensor. Depending on the embodiments, a transparent capacitive sensor can comprise a transparent thin-film transistor that controls chafing of a coupling capacitor. The coupling capacitor can be made from transparent electrode and/or transparent dielectric. Furthermore, a transparent capacitive sensor can comprise a transparent thin-film transistor that controls discharging of the coupling capacitor. In some exemplary embodiments, the same transparent thin-film-transistor can be used for both controlling charging and discharging of the coupling capacitor. In additional exemplary embodiment, a transparent capacitive sensor can comprise an amplifier thin-film-transistor whose gate connects to the transparent sensing electrode.

In some exemplary embodiments, a transparent capacitive sensor can comprise components (e.g., electrode, or dielectric, or thin-film transistor, or scanline, or column line, or data line, or gate control line, or output line, or control line, or coupling line, or readline) made from optically transparent conductive material or optically transparent semi-conductive material.

Transparent conductive materials include but not limited to transparent inorganic materials, or transparent organic materials. Examples of inorganic materials include TCO (transparent conducting oxide), or fluorine doped tin oxide (FTO), or doped zinc oxide, etc.

In accordance with the present invention, a transparent thin-film transistor (TFT) can be implemented using transparent organic thin-film transistors, or transparent in-organic thin-film transistors, or transparent amorphous oxide thin-film transistors, or transparent nano-wire transistors, or transparent nano-tube transistors, etc.

In some exemplary embodiments, a transparent fingerprint imaging apparatus can be integrated with an electronic display (3240) using out-cell technology.

In additional exemplary embodiments, a transparent fingerprint imaging apparatus can act as both a fingerprint imaging device and a touch sensing device. Furthermore, a transparent fingerprint imaging apparatus can support a touch sensing mode, which can be implemented as a state of the transparent fingerprint imaging apparatus. When a transparent fingerprint imaging apparatus is in the touch sensing mode, it is configured to detect presence of touch/touches from human finger or hand, or touch from a stylus. In some exemplary embodiments, in the touch sensing mode, a fingerprint imaging apparatus can select a subset of fingerprint imaging cells for touch detection. Depending on the embodiments, this can be implemented by selecting a subset of scanlines (e.g., gate lines, or control lines), or selecting a subset of column lines (e.g., data lines, or read lines, or output lines). An exemplary embodiment can use one or a plurality of multi-resolution shift registers (e.g., parallel-in parallel-out shift register, or serial-in parallel-out shift register). A multi-resolution shift register can be configured to choose one out of multiple shift distances.

In accordance with the present invention, a fingerprint imaging apparatus can be fabricated using system-on-panel (SOP) or system-onglass (COG) technology. Circuitry components of a fingerprint imaging apparatus can be integrated on a panel.

It is worth to point out that the described embodiments are only for illustration purpose. Equivalent embodiments may be readily apparent to those of ordinary skill in the art. The present invention should not be limited only to the described embodiments herein.

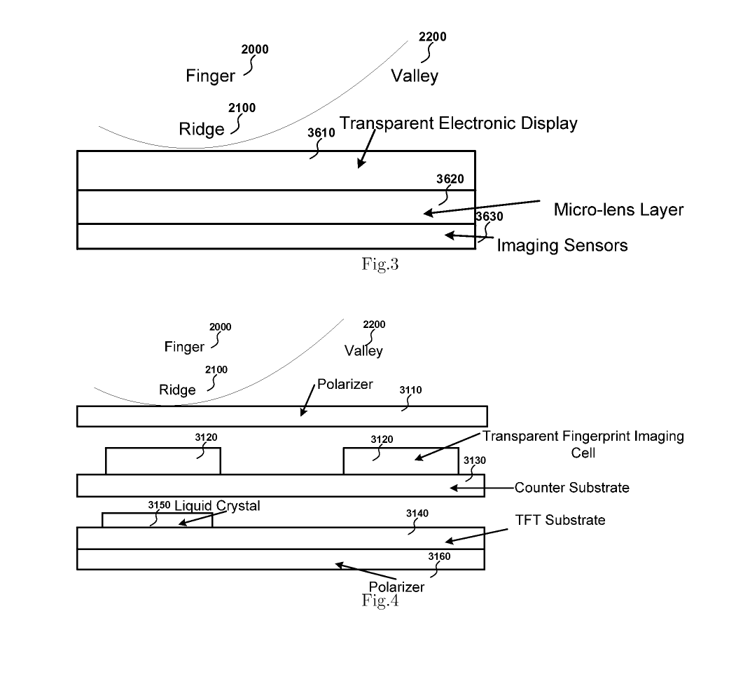

FIG. 3 is a block diagram showing, in one exemplary embodiment of the present invention, a touch-fingerprinting display comprising a transparent electronic display (e.g., transparent OLED) and a fingerprint imaging apparatus.

Depend on the embodiments, a transparent electronic display (e.g., transparent OLED) (3610) can be made to be top-only emitting, bottom-only emitting, or both top and bottom emitting.

In some exemplary embodiments, a touch-fingerprinting display can comprise a pattern of fingerprint imaging sensors (3630) or infrared imaging sensors. An image sensor is a device that converts an optical image into an electronic signal (e.g., digital charge-coupled device (CCD), or complementary metal oxide semiconductor (CMOS) active pixel sensors). An infrared imaging sensor converts an infrared image into an electronic signal.

In further exemplary embodiments, a touch-fingerprinting display can comprise a layer of microlens (3620). A microlens is a small lens. A microlens may be a single element with one plane surface and one spherical convex surface to refract the light.

It is worth to point out that the described embodiments are only for illustration purpose. Equivalent embodiments may be readily apparent to those of ordinary skill in the art. The present invention should not be limited only to the described embodiments herein.

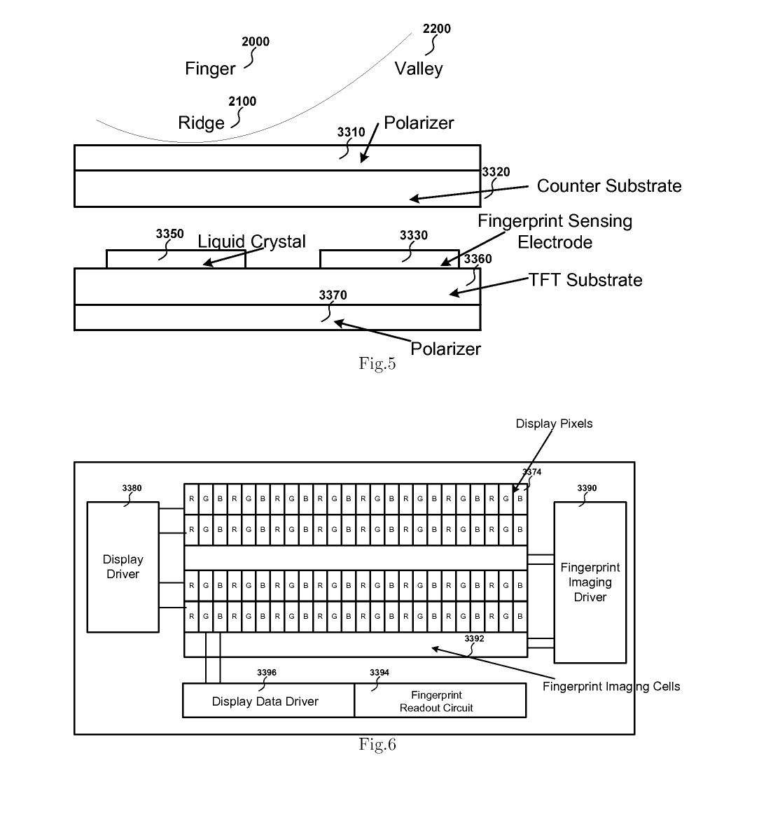

FIG. 4 is a block diagram showing, in one exemplary embodiment of the present invention, a touch-fingerprinting display comprising transparent fingerprint imaging cells integrated with an electronic display.

In some exemplary embodiments, a touch-fingerprinting display can integrate fingerprint imaging cells (3120) and display pixels with a layered structure. In exemplary embodiments where the display is a LCD, the layered touch-fingerprinting display can comprise two polarizer layers (3110 and 3160). Furthermore, the layered touch-fingerprinting display can comprise a layer of fingerprint imaging cells (3120) between the two polarizer layers (3110 and 3160). A layer of fingerprint imaging cells can comprise a matrix of fingerprint imaging cells. In additional exemplary embodiments, the fingerprint imaging cells are made from optically transparent materials. A fingerprint imaging cell can comprise transparent capacitive sensor that can sense the difference between the ridge (2100) and valley (2200) of human finger (2000) and/or hand. Using the principle of capacitance sensing, a transparent capacitive sensor is designed to pick up the difference between finger ridge and valley by inducing a different value in current or voltage. The difference can be further amplified, and converted into digital signal by one or a plurality of analog-to-digital converters, or by one or a plurality of analog-to-digital comparators.

In accordance with the present invention, there can be multiple alternative embodiments of a transparent capacitive sensor. Depending on the embodiments, a transparent capacitive sensor can comprise a transparent thin-film transistor that controls chafing of a coupling capacitor. The coupling capacitor can be made from transparent electrode and/or transparent dielectric. Furthermore, a transparent capacitive sensor can comprise a transparent thin-film transistor that controls discharging of the coupling capacitor. In some exemplary embodiments, the same transparent thin-film-transistor can be used for both controlling charging and discharging of the coupling capacitor. In additional exemplary embodiment, a transparent capacitive sensor can comprise an amplifier thin-film-transistor whose gate connects to the transparent sensing electrode.

In an exemplary embodiment, a layered touch-fingerprinting display can comprise a layer of liquid crystals (3150) arranged in a pattern of LCD display pixels. In additional exemplary embodiments, a display pixel can comprise a plurality of sub-pixels aligned to a colour filter (e.g., three sub-pixels aligned to color filters). A layered touch-fingerprinting display can further include a layer of TFT substrate (3140) that can comprise a matrix of electrodes and thin-film transistors.

In further exemplary embodiments, a layered touch-fingerprinting display can comprise light source (e.g., backlight). In addition, a layered touch-fingerprinting display can comprise a counter substrate (3130) that is between the fingerprint imaging layer and the layer of display pixels.

It is worth to point out that the described embodiments are only for illustration purpose. Equivalent embodiments may be readily apparent to those of ordinary skill in the art. The present invention should not be limited only to the described embodiments herein.

FIG. 5 is a block diagram showing, in one exemplary embodiment of the present invention, a touch-fingerprinting display comprising a layered structure with the fingerprint imaging cells integrated with the display module itself.

In some exemplary embodiments, a touch-fingerprinting display can be made using in-cell LCD technique that integrates fingerprint imaging cells (3330) with the LCD module. Fingerprint imaging cells (e.g., capacitive fingerprint sensing cells, or optical fingerprint sensing cells, or infrared fingerprint sensing cells) can be integrated with the LCD thin-film transistor (TFT) substrate (3360). For a fingerprint imaging cell, the TFT substrate (3360) can comprise a collection of electrodes and thin-film transistors (e.g., amorphous TFT, or microcrystalline TFT, or polysilicon TFT, or organic TFT, or nano-wire TFT, or nano-tube TFT).

In the exemplary embodiments where the touch-fingerprinting display comprises LCD display pixels, the touch-fingerprinting display can comprise multiple layers. The layered structure comprises two polarizer layers (3310 and 3370). Furthermore, the layered touch-fingerprinting display can comprise counter substrate (3320).

In some exemplary embodiments, a fingerprint imaging cell can comprise a capacitive sensor that can sense the difference between the ridge and valley of human finger and/or hand. Using the principle of capacitance sensing, a capacitive sensor is designed to pick up the difference between finger ridge and valley/not touched by inducing a different value in current or voltage. The difference can be further amplified, and converted into digital signal by one or a plurality of analog-to-digital converters, or by one or a plurality of analog-to-digital comparators.

In accordance with the present invention, there can be multiple alternative embodiments of a capacitive sensor. Depending on the embodiments, a capacitive sensor can comprise a thin-film transistor that controls charging of a coupling capacitor. Furthermore, a capacitive sensor can comprise a thin-film transistor that controls discharging of the coupling capacitor. In some embodiments, the same thin-film-transistor can be used for both controlling charging and discharging of the coupling capacitor. In additional embodiment, a capacitive sensor can comprise an amplifier thin-film-transistor whose gate connects to the sensing electrode.

In an exemplary embodiment, a touch-fingerprinting display can comprise a collection of liquid crystals (3350) arranged in a pattern of LCD display pixels. In additional exemplary embodiments, a display pixel can comprise a plurality of sub-pixels aligned to a colour filter (e.g., three sub-pixels aligned to color filters).

In further exemplary embodiments, a layered touch-fingerprinting display can comprise light source (e.g., backlight).

It is worth to point out that the described embodiments are only for illustration purpose. Equivalent embodiments may be readily apparent to those of ordinary skill in the art. The present invention should not be limited only to the described embodiments herein.

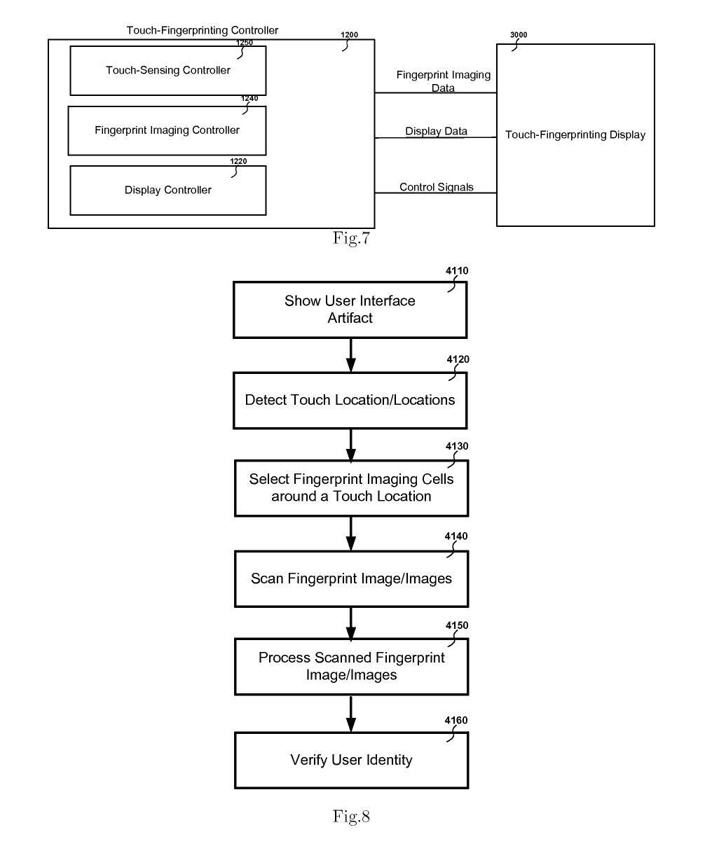

FIG. 6 is a block diagram showing, in one exemplary embodiment of the present invention, a pattern of display pixels and fingerprint imaging cells, display driver, fingerprint imaging driver, and readout circuit.

In an exemplary embodiment, a group of fingerprint imaging cells (e.g., capacitive fingerprint imaging cells, or optical fingerprint imaging cells, or infrared fingerprint imaging cells) (3392) can be placed between groups of LCD display pixels (3374). The display pixels (3374) can be controlled by a display driver (3380). A display driver (3380) is a semiconductor integrated circuit that can control states of display pixels. Depending on the embodiments, a display driver (3380) can provide an interface between a display controller (e.g., a GPU, or a display micro-controller, or a display ASIC, or a SoC) and a display device.

In some exemplary embodiments, a display sub-pixel can comprise one or a plurality of thin-film transistors. Furthermore, there can be a scanline that connects to one of the terminals or gate of a thin-film transistor. There can be data line that connects to a sub-pixel. A display driver (3380) can control the thin-film transistors of a display pixel (3374) by sending control signals. Consequently, the display pixel (3374) can change its state and/or displayed color. A display data driver can supply image data to a display pixel (3374). The display data driver can convert digital pixel data into analog display signals.

In some exemplary embodiments, a fingerprint imaging driver (3390) can control states of fingerprint imaging cells (3392). The fingerprint imaging driver (3390) can connect to the gate or one of the terminals of the thin-film transistors contained by a fingerprint imaging cell (3392).

In some exemplary embodiments, a touch-fingerprinting display can act as both a fingerprint imaging device and a touch sensing device. Furthermore, a touch-fingerprinting display can support a touch sensing mode. When a touch-fingerprinting display is in the touch sensing mode, it is configured to detect presence of touch/touches from human finger or hand, or touch from a stylus. In some exemplary embodiments, in the touch sensing mode, the fingerprint imaging driver (3390) can be configured to select a subset of fingerprint imaging cells (3392) for touch detection. Depending on the embodiments, this can be implemented by selecting a subset of scanlines (e.g., gate lines, or control lines) coupled with the fingerprint imaging cells (3392), or selecting a subset of column lines (e.g., data lines, or read lines, or output lines) coupled with the fingerprint imaging cells (3392). A fingerprint imaging driver (3390) can comprise one or a plurality of multi-resolution shift registers (e.g., parallel-in parallel-out shift register, or serial-in parallel-out shift register). A multi-resolution shift register can be configured to choose one out of multiple shift distances. Furthermore, a fingerprint imaging driver (3390) can comprise one or a plurality of decoders (e.g. scanline decoder, or column decoder, or gate line decoder).

In some exemplary embodiments, a touch-fingerprinting display can comprise a readout circuit (3394) coupled with the fingerprint imaging cells (3392). Depending on the embodiments, the readout circuit (3394) can perform one or multiple of the following operations, amplifying the output collected from a fingerprint imaging cell (3392), converting the fingerprint imaging output into a digital value using an analog-to-digital convertor or an analog-to-digital comparator, storing converted digital data in an electronic storage (e.g., latch, or buffer, or register, or SRAM), selecting output of fingerprint imaging cells (e.g., columns, or data lines, or output lines, or latches, or registers) using one or a plurality of selectors, or transmitting digital or analog output of the selected fingerprint imaging cells to a controller or SoC.

It is worth to point out that the described embodiments are only for illustration purpose. Equivalent embodiments may be readily apparent to those of ordinary skill in the art. The present invention should not be limited only to the described embodiments herein.

FIG. 7 is a block diagram showing, in one exemplary embodiment of the present invention, the components of a touch-fingerprinting controller that comprises a display controller (1220), a touch sensing controller (1250), and a fingerprint imaging controller (1240).

In some exemplary embodiments, a touch-fingerprinting controller (1200) is a semiconductor integrated circuit that controls a touch-fingerprinting display (3000). In further exemplary embodiments, a touch-fingerprinting controller (1200) can couple with a touch-fingerprinting display (3000) by using a communication interface (e.g., TTL, or RS232, or SPI, or I2C, or display serial interface, or low-voltage differential signaling, or USB, or HDMI, or DVI). Depending on the embodiments, a touch-fingerprinting controller (1200) can send display commands and/or display data to a touch-fingerprinting display (3000) to make the display to show text or image. In further exemplary embodiments, a touch-fingerprinting controller can send touch sensing and/or fingerprint imaging control commands to a touch-fingerprinting display by using a communication interface (e.g., TTL, or RS232, or SPI, or I2C, or USB, or serial communication interface, or fireware, or thunderbolt/light peak). In addition, the touch-fingerprinting controller (1200) can receive touch and/or fingerprint sensing data from the touch-fingerprinting display (3000) by using the same communication interface and/or additional communication interface (e.g., TTL, or RS232, or SPI, or I2C, or USB, or serial communication interface, or fireware, or thunderbolt/light peak).

In some additional exemplary embodiments, a touch-fingerprinting controller (1200) can multiplex transmission of display control commands and touch/fingerprint imaging control commands over a communication interface.

In some exemplary embodiments, the touch-fingerprinting controller (1200) can further comprise application-specific micro-controller, or digital signal processor (DSP), or ASIC unit, or SRAM, or DRAM, or Flash memory, or EEPROM or ROM. Firmware and/or binary machine codes can be stored on non-volatile storage (e.g., Flash, or PCM RAM, or magnetic RAM, or resistive memory, or ROM) coupled with a touch-fingerprinting controller (1200). Depending on the embodiments, the non-volatile storage can store display fonts, or instructions or metadata for display control, or instructions or metadata for touch sensing, or instructions or metadata for fingerprint imaging, or instructions or metadata for coordinating touch sensing and fingerprint imaging.

In some additional exemplary embodiments, the touch-fingerprinting controller (1200) can be integrated with a system on a chip (SoC) device or be integrated with a VLSI device using system in a package (SIP). A SoC or SIP device can comprise digital, or analog, or mixed-signal, or radio-frequency functions. Sometimes, the SoC or SIP device with integrated touch-fingerprinting controller (1200) can be used as a component to create a mobile computing apparatus (e.g., tablet, or mobile phone, or mobile Internet device, or handheld gaming device, or PDA).

In some exemplary embodiments, a touch-fingerprinting controller (1200) can comprise a touch sensing controller (1250). A touch sensing controller (1250) can comprise ASIC and/or instructions (e.g., machine code, or micro-controller instructions, or computer instructions, or firmware) that can detect presence of touch from human hand or a stylus, and/or determine the location of the touch from the change of the outputs from a touch-fingerprinting display.

In further exemplary embodiments, a touch sensing controller (1250) or a touch-fingerprinting controller (1200) can additionally comprise one or multiple of the following components, a pre-processing touch sensing unit that performs noise filtering of the signals received from a touch-fingerprinting display, a touch feature extraction unit that extracts features from sensed touch signals received from a touch-fingerprinting display, a touch locating unit that can locate touch location or touch locations.

In some exemplary embodiments, a touch-fingerprinting display (3000) can share fingerprint imaging cells for both touch sensing and fingerprint imaging. A touch-fingerprinting controller (1200) can use fingerprint imaging cell subsampling to detect touch locations. With reduced sampling resolution of fingerprint imaging cell scanlines and/or fingerprint imaging cell columns of a touch-fingerprinting display, a touch-fingerprinting controller can detect touch locations using output from a subset of fingerprint imaging cells. Furthermore, a touch-fingerprinting controller can use higher scanline and/or column resolutions for capturing fingerprint images.

In some exemplary embodiments, fingerprint imaging cells can be multiplexed for touch detection and fingerprint imaging. A touch-fingerprinting controller can comprise a multi-resolution sensing unit. The multi-resolution sensing unit or touch-fingerprint controller can direct a fingerprint imaging driver to use one of the sensing resolutions. A fingerprint imaging driver can comprise support for multi-resolution sampling of fingerprint imaging cells. For touch sensing, a subset of fingerprint imaging cells can be selected. In some exemplary embodiments, this can be achieved by activating and/or selecting a subset of fingerprint imaging scanlines or fingerprint imaging columns.

Depending on the embodiments, there are multiple alternative approaches to support multi-resolution sampling of fingerprint imaging cells. For example, scanlines or columns can be activated with different stride distance value. In one exemplary embodiment, when a scanline or column is selected, the next selected scanline or column is separated from the current scanline or column by one or a plurality of scanlines or columns. As an example, a multi-resolution touch-fingerprinting controller can select every four fingerprint imaging scanlines for touch detection. In further exemplary embodiments, the selected scanlines or columns can be divided into multiple groups where one selected scanline or column of each group is chosen simultaneously. Then the next selected scanline or column of the group is selected.

In some exemplary embodiments, a touch-fingerprinting controller (1200) can additionally comprise a fingerprint imaging controller (1240). A fingerprint imaging controller (1240) can comprise ASIC and/or instructions (e.g., machine code, or micro-controller instructions, or computer instructions, or firmware) that can scan one or multiple fingerprint images from a human finger or hand.

In further exemplary embodiments, a fingerprint imaging controller (1240) or a touch-fingerprinting controller (1200) can additionally comprise one or multiple of the following components to process scanned fingerprint images, a pre-processing unit that performs noise filtering of the fingerprint data received from a touch-fingerprinting display, or a fingerprint feature extraction unit that extracts features from the fingerprint data received from a touch-fingerprinting display, or a fingerprint super-resolution unit that creates fingerprint images with enhanced resolution from a collection of fingerprint images with lower resolution.

In some exemplary embodiments, a fingerprint imaging controller (1240) or a touch-fingerprinting controller (1200) can comprise a fingerprint super-resolution processor. A fingerprint super-resolution processor can extract the independent information from a collection of fingerprint images taken by a touch-fingerprinting display and combine the information into one or multiple fingerprint images with enhanced resolution. Super resolution is used as a solution to create fingerprint images with better quality from blurred fingerprint image, or incomplete fingerprint images, or fingerprint images collected under insufficient sampling resolution. Depending on the embodiments, a fingerprint super-resolution processor can implement one or multiple super resolution (SR) approaches (e.g., SR based on projection onto convex sets, or SR based on non-uniform interpolation, or SR based on frequency domain processing, or SR based on deterministic and stochastic regularization, or SR based on hybrid techniques, or SR based on optical flow).

In some further exemplary embodiments, a touch-fingerprinting controller can first detect touch locations based on the touch sensing data and then select the set of fingerprint imaging cells surrounding the touch location (e.g., activating and/or selecting the scanlines or columns of fingerprint imaging cells that cover the touch location to capture one or multiple fingerprint images). A touch-fingerprinting controller or transparent touch-fingerprinting apparatus can compute a pair of column addresses as beginning and end column addresses, and/or compute a pair of scanline addresses as beginning and end scanline addresses. Then scanlines or columns within the beginning and end addresses are selected or activated. In additional exemplary embodiments, a touch-fingerprinting controller can comprise a sensing resolution switching unit that can set and/or switch the sensing state of a touch-fingerprinting display (3000).

It is worth to point out that the described embodiments are only for illustration purpose. Equivalent embodiments may be readily apparent to those of ordinary skill in the art. The present invention should not be limited only to the described embodiments herein.

FIG. 8 is a flowchart showing, in one exemplary embodiment of the present invention, the process of verifying user identity by a computing apparatus during the user's interaction with a user interface artifact. An interface artifact can be a graphic user interface component (e.g., button, or icon, or menu, or widget, or switch). In some exemplary embodiments of the present invention, a user interface artifact can comprise, a home button, or an icon of an application, or a search button, or a back button, or a start button (e.g., power on), or a restart button, or a power off button, or a setting button, or a browser button, or a file open button, or a submit button, or a login button, or a logoff button, or a confirm button, or a ok button, or a cancel button, or an application launch button, or a virtual keypad (keypad displayed on a touch based computing apparatus).

In accordance with the present invention, in some exemplary embodiments, a computing apparatus can display a user interface artifact on a touch-fingerprinting display (4110). Then the computing apparatus can wait for the user's response and detect touches from a user (4120). When the user interface artifact is touched, the computing apparatus can calculate the corresponding touch location and determine a fingerprint imaging region that will cover the touch finger (4130). Then, the computing apparatus scans one or multiple fingerprint images (4140). Depending on the embodiments, data collected from a touch-fingerprinting display can be processed by the readout circuit, and/or touch-fingerprinting controller (1200), and/or the main processing element of a computing apparatus (e.g., SoC, or central processing unit, or embedded processor, or micro-processor) (4150).

In some exemplary embodiments, a readout circuit can convert fingerprint imaging output signal into digital data. In addition, a computing apparatus can comprise a signal processing unit (e.g., ASIC, or DSP, or micro-controller) that performs noise filtering of the fingerprint data received from a touch-fingerprinting display. In further exemplary embodiments, a computing apparatus can comprise a fingerprint super-resolution processor that can create fingerprint images with enhanced resolution from a collection of fingerprint images with lower resolution. After that, depending on the embodiments, the fingerprint image can be admitted for identity verification.

In some exemplary embodiments, a fingerprint super-resolution processor can extract the independent information from a collection of fingerprint images taken by a touch-fingerprinting display and combine the information into one or multiple fingerprint images with enhanced resolution. Super resolution is used as a solution to create fingerprint images with better quality from blurred fingerprint image, or incomplete fingerprint images, or fingerprint images collected under insufficient sampling resolution. Depending on the embodiments, a fingerprint super-resolution processor can implement one or multiple super resolution (SR) approaches (e.g., SR based on projection onto convex sets, or SR based on non-uniform interpolation, or SR based on frequency domain processing, or SR based on deterministic and stochastic regularization, or SR based on hybrid techniques, or SR based on optical flow).

In some exemplary embodiments, an identity verifier (1400) can verify user identity based on scanned fingerprint image or fingerprint images (4160). In additional exemplary embodiments, the computing apparatus can comprise a repository of user identities. Furthermore, the user identities can be stored in one or a plurality of storage devices (e.g., Flash memory, or non-volatile DRAM, or PCM non-volatile storage, or hard disk, or resistive memory).

In some exemplary embodiments, an identity repository can store fingerprint identity data for one or a plurality of users (e.g., owner or primary user of the computing apparatus, and/or children of the primary user of a computing apparatus, and/or spouse of the primary user of a computing apparatus, and/or colleagues of the primary user of a computing apparatus, and/or friends of the primary user of a computing apparatus, and/or administrator of a computing apparatus). Depending on the embodiments, a fingerprint identity can comprise an image template, or other captured sample, in its original, or processed (e.g., features or fingerprint template), or enhanced, or compressed, or encrypted form.

Depending on the embodiments, a computing apparatus or an identity verifier can extract features from fingerprint image data and match the features with fingerprint templates. A computing apparatus or an identity verifier can apply any data processing necessary for fingerprint verification on one or multiple scanned fingerprint images (e.g., decoding, or decryption, or noise filtering, or super-resolution, or image enhancement, or feature extraction, or pattern recognition, or pattern classification).

In additional exemplary embodiments, a computing apparatus or an identity verifier can apply any data processing necessary for fingerprint verification on one or multiple stored fingerprint templates (e.g., decoding, or decryption, or feature extraction, or pattern matching).

The computing apparatus response to a user's touch interaction with one or multiple user interface artifacts by taking certain actions (e.g., open a file by a file opener, or open a folder by a browser, or disable identity protection, or enable identity protection, or launch a software application by an application launcher, or unlock a computing apparatus, or access an electronic document, or establish a network connection with a service or facility over networks, or issue an action by a computing apparatus, or control a peripheral device coupled with a computing apparatus).

In some exemplary embodiments, a computing apparatus can program a SoC or central processing unit to perform the operations illustrated in FIG. 8. The instructions for performing the operations illustrated in FIG. 8 can be stored in one or a plurality of electronic storages (e.g., Flash memory, or DRAM, or hard disk, or ROM, or PCM memory, or magnetic memory, or SRAM, or solid-state disk). In further exemplary embodiments, the instructions can be stored in the original format, or encoded format, or compressed format, or encrypted format.

It is worth to point out that the described embodiments are only for illustration purpose. Equivalent embodiments may be readily apparent to those of ordinary skill in the art. The present invention should not be limited only to the described embodiments herein.

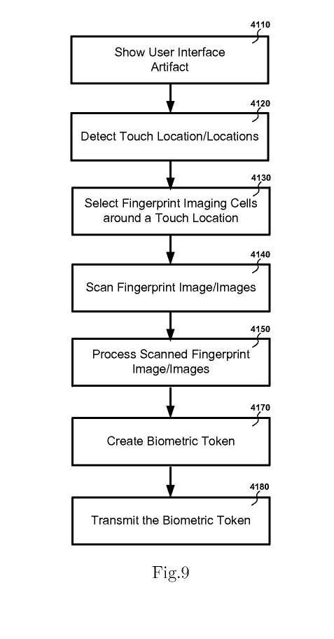

FIG. 9 is a flowchart showing, in one exemplary embodiment of the present invention, the process of transmitting user identity over a network by a computing apparatus during the user's interaction with a computing apparatus.

In accordance with the present invention, a user can use a computing apparatus to access a networked resource (e.g., a networked service, or a remote facility, or online information, or a server, or a networked facility, or a networked device, or a user account including but not limited to bank account, or email account, or web site account, or login account, or user account of a server, or service account, or access account) over a network (e.g., wired network, or wireless network, or cable network, or satellite network, or Internet, or local network, or cellular network). A computing apparatus can comprise one or a plurality of transceivers (e.g., wireless transceiver, or wired transceiver) that support data exchange with a networked resource. A user can access a networked resource by transmitting and/or receiving data between a computing apparatus and a networked resource.

Depending on the embodiments, a user can access a networked resource by interacting with a user interface. A computing apparatus can show a user interface on a touch-fingerprinting display that facilitates a user to access a networked resource. A user can invoke one or multiple operations to access a networked resource by interacting with a user interface. The kinds of operations include but not limited, issuing a request to a networked resource, or submitting a finance transaction, or initiating a finance transaction, or issuing a command to a networked resource, or establishing a protected communication channel, or logging into a networked service, or logging into a networked facility, or proving a user's identity to a networked resource, or uploading data to a networked service, or downloading information from a networked resource, or transmitting an electronic document, or issuing a request to a networked resource, or configuring a networked resource.

In some exemplary embodiments, a user interface can comprise one or a plurality of user interface artifacts. A user can access a networked resource by operating on the user interface artifacts though touch interactions. A computing apparatus can detect the touches and/or scan fingerprint images using a touch-fingerprinting display.

Depending on the embodiments, an interface artifact can be a graphic user interface component (e.g., button, or icon, or menu, or widget, or switch). In some exemplary embodiments of the present invention, a user interface artifact can include but not limited, a home button, or an icon of an application, or a search button, or a back button, or a start button, or a restart button, or a power off button, or a setting button, or a browser button, or a file open button, or a submit button, or a login button, or a logoff button, or a confirm button, or an ok button, or a cancel button, or an application launch button, or a virtual keypad, or a request button, or a stop button, or a switch button.

In accordance with the present invention, some networked resource can be provided by one or a plurality of servers. A user can access the networked resource provided by the server over a network by interacting with a computing apparatus. Depending on the embodiments, a server is a computer system used to run one or more services as a host to serve the needs of a user on the networks. The kinds of servers include but not limited, database server, or a file server, or a mail server, or a print server, or a transaction server, or a payment server, or an administration server, or a web server, or a gaming server, or a server that allows a user to control and/or operate a machine (e.g., vehicle, or weapon system, or mechanical system, or robot, or physical entrance). Depending on the implementations, a server can be a real computer or a virtual server (e.g., virtual machine, or virtual host, or virtual server in a cloud). A server can provide access to a resource (e.g., physical resource, or virtual resource, or logical resource, or digital resource).

In some exemplary embodiments, a server can enforce access control to the networked resource that it hosts. For example, it allows authorized user to access a networked resource. A computing apparatus can use a touch-fingerprinting display to scan one or multiple fingerprint images and demonstrate to a networked resource that a resource is accessed by one of the authorized users. A computing apparatus can transmit digital proof of a user's identity over networks (e.g., wired network, or wireless network, or cable network, or satellite network, or Internet, or local network, or cellular network). In accordance with the present invention, in some exemplary embodiments, after displaying a user interface (4110) on a touch-fingerprinting display by a computing apparatus, the computing apparatus can wait for the user's response and detect touches from a user (4120). When the user interface artifact is touched, the computing apparatus can calculate the corresponding touch location and determine a fingerprint imaging region that will cover the touch finger (4130). Then, the computing apparatus scans one or multiple fingerprint images (4140). Depending on the embodiments, data collected from a touch-fingerprinting display can be processed by the readout circuit, and/or touch-fingerprinting controller (1200), and/or the main processing element of a computing apparatus (e.g., SoC, or central processing unit, or embedded processor, or micro-processor)(4150).

In some exemplary embodiments, a readout circuit can convert fingerprint imaging output signal into digital data. In addition, a computing apparatus can comprise a signal processing unit (e.g., ASIC, or DSP, or micro-controller) that performs noise filtering of the fingerprint data received from a touch-fingerprinting display. In further exemplary embodiments, a computing apparatus can comprise a fingerprint super-resolution unit that can create fingerprint images with enhanced resolution from a collection of fingerprint images with lower resolution. After that, depending on the embodiments, the fingerprint image can be admitted for establishing an identity proof.

In some exemplary embodiments, a fingerprint super-resolution processor can extract the independent information from a collection of fingerprint images taken by a touch-fingerprinting display and combine the information into one or multiple fingerprint images with enhanced resolution. Super resolution is used as a solution to create fingerprint images with better quality from blurred fingerprint image, or incomplete fingerprint images, or fingerprint images collected under insufficient sampling resolution. Depending on the embodiments, a fingerprint super-resolution processor can implement one or multiple super resolution (SR) approaches (e.g., SR based on projection onto convex sets, or SR based on non-uniform interpolation, or SR based on frequency domain processing, or SR based on deterministic and stochastic regularization, or SR based on hybrid techniques, or SR based on optical flow).

In some exemplary embodiments, a computing apparatus can apply any data processing necessary for fingerprint verification on one or multiple scanned fingerprint images (e.g., decoding, or decryption, or noise filtering, or super-resolution, or image enhancement, or feature extraction, or pattern recognition, or pattern classification).

In some exemplary embodiments, an identity proof can comprise a biometric token. A biometric token is a digital security token created from biometric data (e.g., one or multiple original fingerprint images, or features extracted from one or multiple fingerprint images, or one or multiple processed fingerprint images)(4170). A biometric token can be used to control access to a local or a networked resource, or authenticate a user, or prove one's identity electronically (e.g., a user trying to access a networked resource). In additional exemplary embodiments, a biometric token can be used in addition to or in place of a password to prove that the user is who they claim to be. A biometric token can act like an electronic key to access something (e.g., a networked resource, or a local resource).

In some exemplary embodiments, a biometric token can be created from the original or processed fingerprint image, or created from one or a plurality of features extracted from the original or processed fingerprint image (4170). In addition, biometric token can be created by applying one or multiple steps of cryptographic operations to biometric data.

In some exemplary embodiments, a computing apparatus can comprise a crypto processor that can create a biometric token from biometric data. Depending on the embodiments, a crypto processor is a component for carrying out cryptographic and/or security operations. Depending on the implementation, a crypto processor can provide support for creating public-private key pair (e.g., Diffie-Hellman key exchange protocol, or DSS, or ElGamal, Various elliptic curve techniques, or Paillier crypto schemes, or RSA encryption approaches, or CramerShoup crypto schemes), or verifying electronic certificates, or signing digital signatures (e.g., RSA based signature, or DSA based signature, or elliptic curve based DSA, or ElGamal signature, or Rabin signature approach, or Pairing based signature scheme, or undeniable signature, or aggregate signature), or computing message authentication codes for digital data, or performing mutual authentications, or carrying out symmetric key encryption (e.g., Twofish, or Serpent, or AES, or Blowfish, or CAST5, or RC4, or 3DES, or IDEA), or performing digital hash functions (e.g., Gost, or Haval, or MD5, or Panama, or Ripemd, or SHA-1, or SHA-256, or SHA-512, or SHA-3, or Whirlpool), etc. A computing apparatus can create a biometric token by applying one or multiple cryptographic operations on fingerprint data (e.g., in original form, or in processed form, or features extracted from fingerprint images). Depending on the embodiments, as one step of biometric token creation, a computing apparatus can apply a one-way hash operation to fingerprint data (e.g., in original form, or in processed form, or features extracted from fingerprint images).

In some exemplary embodiments, a computing apparatus can submit a biometric token to a networked resource to prove a user's identity (4180). A computing apparatus can transmit a biometric token to one or multiple servers over networks. Depending on the embodiments, a computing apparatus can transmit a biometric token in processed format, or encoded format, or encrypted format over networks using one of its transceivers (e.g., wireless transceiver, or wired transceiver). Depending on the embodiments, transmission of a biometric token over a network can be performed by a transaction processor.

Depending on the implementation, a computer apparatus can transmit a biometric token (e.g., processed format, or encoded format, or encrypted format) using any communication protocol or protocol stack (e.g., hap, or TCP/IP, or https, or UDP)(4180).

In some exemplary embodiments, a computing apparatus can use a browser or an application software to access a networked resource. Depending on the implementation, a browser or an application can transmit biometric token to one or multiple servers over networks. Depending on the embodiments, a browser is a software application for retrieving, presenting and traversing information resources on the World Wide Web. Examples of web browsers include but not limited to Chrome, Firefox, Internet Explorer, Opera, Safari, etc. A networked resource can receive request from the browser over networks and send response back. Depending on the applications and/or embodiments, a networked resource can verify a user's identity by processing a biometric token transmitted from a computing apparatus (4180). In some exemplary embodiments, a networked resource can allow a computing apparatus and/or a user who is interacting with the computing apparatus to access the networked resource if it can verify the user's identity by processing the biometric token received from the computing apparatus.

In some exemplary embodiments, a computing apparatus can program a SoC or central processing unit to perform the operations illustrated in FIG. 9. The instructions for performing the operations illustrated in FIG. 9 can be stored in one or a plurality of electronic storages (e.g., Flash memory, or DRAM, or hard disk, or ROM, or PCM memory, or magnetic memory, or SRAM, or solid-state disk). In further exemplary embodiments, the instructions can be stored in the original format, or encoded format, or compressed format, or encrypted format. In further exemplary embodiments, the instructions for performing the operations illustrated in FIG. 9 can be downloaded from a server over networks to a computing apparatus (in the original format, or encoded format, or compressed format, or encrypted format). After downloaded, the computing apparatus can store the instructions in an electronic storage attached to or coupled with the computing apparatus.

It should be understood that there exists implementations of other variations and modifications of the invention and its various aspects, as may be readily apparent to those of ordinary skill in the art, and that the invention is not limited by the specific embodiments described herein.

What is claimed is:

1. A touch-fingerprinting display apparatus comprising,
a pattern of display pixels wherein said display pixels are controllable components of an electronic display;
a pattern of fingerprint imaging cells wherein said fingerprint imaging cells are interspersed among or placed on top of or placed beneath the display pixels;
a display driver coupled with the display pixels wherein said display driver can control states of the display pixels; and
a fingerprint readout circuit coupled with the fingerprint imaging cells wherein said fingerprint readout circuit senses output of the fingerprint imaging cells.

2. The apparatus in claim 1 wherein the display pixel is an electrophoretic display pixel.

3. The apparatus in claim 1 wherein the display pixel is an organic light emitting diode display pixel.

4. The apparatus in claim 1 wherein the display cell is a liquid crystal display pixel.

5. The apparatus in claim 4 wherein the liquid crystal display cell is a ferroelectric liquid crystal display pixel.

6. The apparatus in claim 1 wherein the fingerprint imaging cell further comprising a capacitive sensing electrode coupled with one or a plurality of thin-film transistors.

7. The apparatus in claim 6 wherein the capacitive sensing electrode further comprising optically transparent conductive material.

8. The apparatus in claim 1 wherein the fingerprint imaging cell further comprising an optical imaging sensor or infrared imaging sensor.

9. The apparatus in claim 8 wherein the fingerprint imaging cell further comprising one or a plurality of micro-lens.

10. The apparatus in claim 1 wherein the fingerprint imaging cell is placed as a neighbor of one or a plurality of display pixels.

11. A touch-fingerprinting controller apparatus wherein said touch-fingerprinting controller apparatus can be coupled with a touch-fingerprinting display wherein said touch-fingerprinting display comprising a pattern of display pixels and a pattern of fingerprint imaging cells, said touch-fingerprinting controller apparatus comprising,
a touch sensing controller wherein said touch sensing controller can determine touch location from output of the fingerprint imaging cells or output of the touch-fingerprinting display; and
a fingerprint imaging controller wherein said fingerprint imaging controller is coupled with the fingerprint imaging cells and/or a fingerprint readout circuit wherein said fingerprint readout circuit is coupled with the fingerprint imaging cells.

12. The apparatus in claim 11 further comprising a display controller wherein said display controller can instruct the touch-fingerprinting display to display an image by switching the states of the display pixels.

13. The apparatus in claim 11 further comprising a sensing resolution switching unit wherein said sensing resolution switching unit can select a higher sampling resolution of fingerprint imaging cells for scanning fingerprint and/or select a lower sampling resolution of fingerprint imaging cells for detecting touch presence.

14. A computing apparatus comprising,
a touch-fingerprinting display wherein said touch-fingerprinting display further comprising, a pattern of display pixels, and a pattern of fingerprint imaging cells wherein said fingerprint imaging cells are interspersed among or placed on top of or placed beneath the display pixels, and a display driver coupled with the display pixels wherein said display driver can control states of the display pixels, and a fingerprint readout circuit coupled with the fingerprint imaging cells wherein said fingerprint readout circuit controls and/or senses output of the fingerprint imaging cells;
a touch-fingerprinting controller wherein said touch-fingerprinting controller is coupled with a touch-fingerprinting display wherein said touch-fingerprinting controller comprising, a touch sensing controller wherein said touch sensing controller can determine touch presence and/or touch location from output of the fingerprint imaging cells or from output of the touch-fingerprinting display, and a fingerprint imaging controller wherein said fingerprint imaging controller is coupled with the fingerprint imaging cells and/or the fingerprint readout circuit;
at least one transceiver;
at least one electronic storage device; and
at least one control processing element wherein said control processing element can be programmed to, instruct the touch-fingerprinting display to show one or a plurality of user interface artifacts, and instruct the touch-fingerprinting controller to scan one or a plurality of fingerprint images.

15. The apparatus in claim 14 further comprising an identity verifier wherein said identity verifier can compare a fingerprint image or compare features extracted from a fingerprint image with one or a plurality of registered fingerprint templates wherein said registered fingerprint templates are created from fingerprint images of one or a plurality of authorized persons.

16. The apparatus in claim 14 further comprising a supper-resolution processor that creates a fingerprint image with enhanced resolution from one or a plurality of low resolution fingerprint images.

17. The apparatus in claim 14 further comprising a user interface processor wherein said user interface processor can instruct the touch-fingerprinting display to show one or a plurality of user interface artifacts.

18. The user interface artifact in claim 17 is a login icon or submit button.

19. The apparatus in claim 14 further comprising a biometric processor wherein said biometric processor can create one or a plurality of electronic biometric tokens from one or a plurality of fingerprint images.

20. The apparatus in claim 19 further comprising a transaction processor wherein said transaction processor can transmit said electronic biometric token over one or a plurality of transceivers.
